(19) United States
(12) Patent Application Publication
(10) Pub. No.: US 2004/0112880 A1
(43) Pub. Date: Jun. 17, 2004

(54) Laser machining method

(76) Inventor: Kazuma Sekiya, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/721,234

(22) Filed: Nov. 26, 2003

(30) Foreign Application Priority Data
Dec. 13, 2002 (JP) 2002-361882

(51) Int. Cl. B23K 26/38

(52) U.S. Cl. 219/121.69

(57) ABSTRACT

A laser machining method for machining a workpiece by applying a laser beam thereto, comprises a protective film coating step of coating a surface to be machined, of the workpiece with a protective film; a laser beam shining step of applying a laser beam to the workpiece through the protective film; and a protective film removal step of removing the protective film after completion of the laser beam shining step.

### FIELD OF THE INVENTION

This invention relates to a laser machining method for applying a laser beam to a predetermined region of a workpiece to perform predetermined machining.

### DESCRIPTION OF THE PRIOR ART

In a semiconductor device manufacturing process, as is well known among people skilled in the art, a plurality of regions are demarcated by streets (cutting lines) arranged in a lattice pattern on the face of a nearly disk-shaped semiconductor wafer, and a circuit such as IC or LSI or the like is formed in each of the demarcated regions. This semiconductor wafer is cut along the streets to divide it into the respective circuits, thereby producing individual semiconductor chips. Cutting along the streets of the semiconductor wafer is performed normally by a cutting device called a dicer. This cutting device comprises a chuck table for holding the semiconductor wafer that is the workpiece, a cutting means for cutting the semiconductor wafer held by the chuck table, and a moving means for moving the chuck table and the cutting means relative to each other. The cutting means comprises a rotary spindle to be rotated at a high speed, and a cutting blade mounted on the spindle. The cutting blade comprises a disk-shaped base, and an annular cutting edge mounted on an outer peripheral portion of the side surface of the base. The cutting edge comprises diamond abrasive grains (for example, about 3 μm in particle size) fixed by electroforming, and is formed to have a thickness of about 20 μm. When the semiconductor wafer is cut by such a cutting blade, a fracture or crack occurs on the cut surface of the semiconductor chip cut off. Therefore, the width of the street is set at about 50 μm in consideration of the influence of the fracture or crack. If the semiconductor chip is downsized, however, the proportion of the street to the semiconductor chip increases to cause a decrease in productivity. Cutting by the cutting blade, moreover, poses problems that the feed speed is limited, and the semiconductor chips are contaminated with swarf.

In recent times, the following semiconductor wafers have been put to practical use for finer fabrication of circuits such as IC and LSI: Semiconductor wafers in which a low dielectric constant insulator (Low-k film) comprising a film of an inorganic material such as SiOF or BSG (SiOB), or a film of an organic material such as a polyimide-based or parylene-based polymer film, has been laminated on the face of a semiconductor wafer body such as a silicon wafer; and semiconductor wafers having a metal pattern called a test element group (Teg) applied thereto. The semiconductor wafers having the low dielectric constant insulator (Low-k film) laminated thereon involve a problem that when they are cut along the street by a cutting blade, the low dielectric constant insulator peels off. The semiconductor wafers having a metal pattern called the test element group (Teg) applied thereto pose a problem that when they are cut along the street by a cutting blade, burrs occur because the metal pattern is formed from a tacky metal such as copper or the like.

A machining method, in which a laser beam is shone along the street of a semiconductor wafer to cut the semiconductor wafer, has also been attempted. This method is disclosed in Japanese Unexamined Patent Publication No. 1994-120334.

This method of cutting by shining a laser beam is of the type for dividing the semiconductor wafer along the street by using the laser beam. Accordingly, this method can solve the problem of peeling-off of the low dielectric constant insulator layer and can also solve the problem of occurrence of the burr.

However, this method creates a new problem that when a laser beam is shone along the street of the semiconductor wafer, thermal energy concentrates in the shone region to cause debris, and the debris adhere to bonding pads, etc. that are connected to the circuit, thereby deteriorating the quality of the semiconductor chips.

### SUMMARY OF THE INVENTION

The object of the present invention is to provide a laser machining method which can prevent the influence of debris produced upon applying a laser beam to a workpiece.

According to the present invention, for attaining the above object, there is provided a laser machining method for machining a workpiece by applying a laser beam thereto, which comprises:

a protective film coating step of coating a surface to be machined, of the workpiece with a protective film;

a laser beam shining step of applying a laser beam to the workpiece through the protective film; and

a protective film removal step of removing the protective film after completion of the laser beam shining step.

According to the present invention, there is also provided a laser machining method for cutting a workpiece by moving the workpiece relative to a laser beam shining means while applying a laser beam to the workpiece by the laser beam shining means, which comprises:

a protective film coating step of coating a surface to be machined, of the workpiece with a protective film;

a laser beam shining step of applying a laser beam to the workpiece through the protective film; and

a protective film removal step of removing the protective film after completion of the laser beam shining step.

The protective film may be formed by coating the to-be-machined surface with a liquid resin and allowing the resulting coating to be hardened with the passage of time. Alternatively, the protective film may be formed by sticking a sheet member to the surface to be machined. This liquid resin or sheet member is desirably water- soluble.

Other characteristics of the present invention will become apparent from the description to follow.

### BRIEF DESCRIPTION OF THE DRAWINGS

FIG. 1 is a perspective view of a laser machining apparatus for performing the laser machining method according to the present invention.

FIG. 2 is a block diagram schematically showing the constitution of a laser machining means provided in the laser machining apparatus shown in FIG. 1.

FIG. 3 is a perspective view of a semiconductor wafer as a workpiece to be machined, by the laser machining method according to the present invention.

FIG. 4 is an explanatory drawing showing an embodiment of a protective film coating step in the laser machining method according to the present invention.

FIG. 5 is an enlarged sectional view of an essential part of a semiconductor wafer as a workpiece which has been coated with a protective film by the protective film coating step shown in FIG. 4.

FIG. 6 is an explanatory drawing showing another embodiment of the protective film coating step in the laser machining method according to the present invention.

FIG. 7 is a perspective view showing a state in which the semiconductor wafer as the workpiece coated with the protective film is supported by an annular frame via a protective tape.

FIG. 8 is an explanatory drawing showing a laser beam shining step in the laser machining method according to the present invention.

FIG. 9 is an enlarged sectional view of the essential part of the semiconductor wafer as the workpiece machined by the laser machining method according to the present invention.

### DETAILED DESCRIPTION OF THE PREFERRED EMBODIMENTS

The laser machining method according to the present invention will now be described in greater detail by reference to the accompanying drawings.

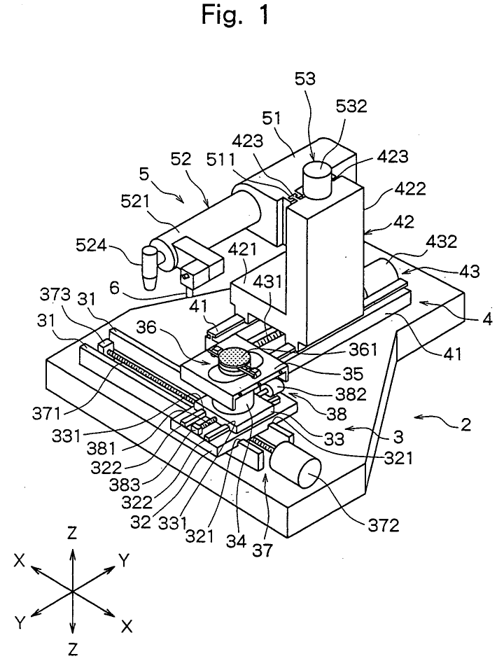

FIG. 1 shows a perspective view of a laser machining apparatus which applies a laser beam to a workpiece such as a semiconductor wafer or the like, in the laser machining method according to the present invention. The laser machining apparatus shown in FIG. 1 comprises a stationary base 2; a chuck table mechanism 3 that is disposed on the stationary base 2 so as to be movable in a direction indicated by arrows X and holds a workpiece; a laser beam shining unit support mechanism 4 disposed on the stationary base 2 so as to be movable in a direction indicated by arrows Y that is perpendicular to the direction indicated by the arrows X; and a laser beam shining unit 5 disposed on the laser beam shining unit support mechanism 4 so as to be movable in a direction indicated by arrows Z.

The chuck table mechanism 3 comprises a pair of guide rails 31, 31 disposed parallel on the stationary base 2 along the direction indicated by the arrows X; a first slide block 32 disposed on the guide rails 31, 31 so as to be movable in the direction indicated by the arrows X; a second slide block 33 disposed on the first slide block 32 so as to be movable in the direction indicated by the arrows Y; a support table 35 supported on the second slide block 33 by a cylindrical member 34; and a chuck table 36 as a workpiece holding means. This chuck table 36 has an adsorption chuck 361 formed from a porous material, and is constituted to hold, for example, a disk-shaped semiconductor wafer, which is a workpiece, on the adsorption chuck 361 by a suction means (not shown). The chuck table 36 is rotated by a pulse motor (not shown) disposed within the cylindrical member 34.

The first slide block 32 has, on its lower surface, a pair of to-be-guided grooves 321, 321 to be fitted onto the pair of guide rails 31, 31, and has, on its upper surface, a pair of guide rails 322, 322 formed in parallel along the direction indicated by the arrows Y. The so constituted first slide block 32 is constituted to be movable along the pair of guide rails 31, 31 in the direction indicated by the arrows X by fitting the to-be-guided grooves 321, 321 onto the pair of guide rails 31, 31. The chuck table mechanism 3 in the illustrated embodiment has a moving means 37 for moving the first slide block 32 along the pair of guide rails 31, 31 in the direction indicated by the arrows X. The moving means 37 comprises an externally threaded rod 371 disposed between the pair of guide rails 31 and 31 and in parallel thereto, and a drive source such as a pulse motor 372, for rotationally driving the externally threaded rod 371. The externally threaded rod 371 is, at its one end, rotatably supported by a bearing block 373 fixed to the stationary base 2, and is, at the other end, drive-transmission coupled to an output shaft of the pulse motor 372 via a reduction gear (not shown). The externally threaded rod 371 is screwed to an internally threaded through-hole formed in an internal thread block (not shown) provided projectingly on the lower surface of a central portion of the first slide block 32. Thus, the externally threaded rod 371 is driven normally and reversely rotationally by the pulse motor 372, whereby the first slide block 32 is moved along the guide rails 31, 31 in the direction of the arrows X.

The second slide block 33 has, on its lower surface, a pair of to-be-guided grooves 331, 331 to be fitted onto the pair of guide rails 322, 322 provided on the upper surface of the first slide block 32. The second slide block 33 is constituted to be movable in the direction indicated by the arrows Y by fitting the to-be-guided grooves 331, 331 onto the pair of guide rails 322, 322. The chuck table mechanism 3 in the illustrated embodiment has a moving means 38 for moving the second slide block 33 along the pair of guide rails 322, 322, which are provided on the first slide block 32, in the direction indicated by the arrows Y. The moving means 38 comprises an externally threaded rod 381 disposed between the pair of guide rails 322 and 322 and in parallel thereto, and a drive source such as a pulse motor 382, for rotationally driving the externally threaded rod 381. The externally threaded rod 381 is, at one end, rotatably supported by a bearing block 383 fixed to the upper surface of the first slide block 32, and is, at the other end, drive-transmission coupled to an output shaft of the pulse motor 382 via a reduction gear (not shown). The externally threaded rod 381 is screwed to an internally threaded through-hole formed in an internal thread block (not shown) provided projectingly on the lower surface of a central portion of the second slide block 33. Thus, the externally threaded rod 381 is driven normally and reversely rotationally by the pulse motor 382, whereby the second slide block 33 is moved along the guide rails 322, 322 in the direction of the arrows Y.

The laser beam shining unit support mechanism 4 has a pair of guide rails 41, 41 disposed in parallel on the stationary base 2 along an index feed direction indicated by the arrows Y, and a moving support base 42 disposed on the guide rails 41, 41 so as to be movable in the direction indicated by the arrows Y. The moving support base 42 comprises a moving support portion 421 disposed movably on the guide rails 41, 41, and a mounting portion 422 attached to the moving support portion 421. The mounting portion 422 has, on its side surface, a pair of guide rails 423, 423 provided in parallel and extending in the direction indicated by the arrows Z. The laser beam shining unit support mechanism 4 in the illustrated embodiment has a moving means 43 for moving the moving support base 42 along the pair of guide rails 41, 41 in the direction indicated by the arrows Y that is the index feed direction. The moving means 43 comprises an externally threaded rod 431 disposed between the pair of guide rails 41 and 41 and in parallel thereto, and a drive source such as a pulse motor 432, for rotationally driving the externally threaded rod 431. The externally threaded rod 431 is, at one end, rotatably supported by a bearing block (not shown) fixed to the stationary base 2, and is, at the other end, drive-transmission coupled to an output shaft of the pulse motor 432 via a reduction gear (not shown). The externally threaded rod 431 is screwed to an internally threaded hole formed in an internal thread block (not shown) provided projectingly on the lower surface of a central portion of the moving support portion 421 which constitutes the moving support base 42. Thus, the externally threaded rod 431 is driven normally and reversely rotationally by the pulse motor 432, whereby the moving support base 42 is moved along the guide rails 41, 41 in the index feed direction indicated by the arrows Y.

The laser beam shining unit 5 in the illustrated embodiment is equipped with a unit holder 51, and a laser beam shining means 52 attached to the unit holder 51. The unit holder 51 has a pair of to-be-guided grooves 511, 511 to be slidably fitted onto the pair of guide rails 423, 423 provided on the mounting portion 422. The to-be-guided grooves 511, 511 are fitted onto the pair of guide rails 423, 423, whereby the unit holder 51 is supported so as to be movable in the direction indicated by the arrows Z.

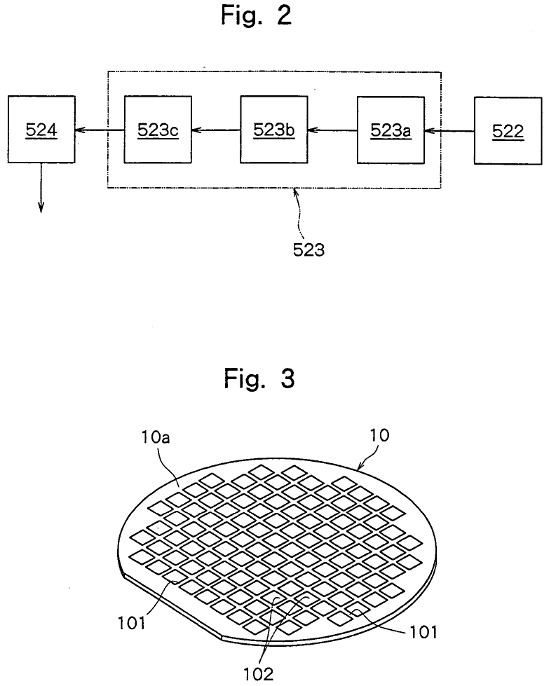

The illustrated laser beam shining means 52 comprises a cylindrically shaped casing 521 that is fixed to the unit holder 51 and extends substantially horizontally. Within the casing 521, a laser beam oscillation means 522 and a laser beam modulation means 523 are disposed as shown in FIG. 2. As the laser beam oscillation means 522, a YAG laser oscillator or a YVO4 laser oscillator can be used. The laser beam modulation means 523 comprises a pulse repetition frequency setting means 523a, a laser beam pulse width setting means 523b, and a laser beam wavelength setting means 523c. The pulse repetition frequency setting means 523a, laser beam pulse width setting means 523b, and laser beam wavelength setting means 523c constituting the laser beam modulation means 523 may be of types well known among people skilled in the art and hence, detailed explanations for their constitutions are omitted herein. An optical condenser 524, which may be of a well-known type per se, is mounted at the front end of the casing 521.

A laser beam oscillated by the laser beam oscillation means 522 arrives at the optical condenser 524 via the laser beam modulation means 523. In the laser beam modulation means 523, the pulse repetition frequency setting means 523a converts the laser beam into a pulse laser beam of a predetermined pulse repetition frequency, the laser beam pulse width setting means 523b sets the pulse width of the pulse laser beam at a predetermined width, and the laser beam wavelength setting means 523c sets the wavelength of the pulse laser beam at a predetermined value.

An imaging means 6 is disposed at a front end portion of the casing 521 constituting the laser beam shining means 52. In the illustrated embodiment, the imaging means 6 is constituted by an ordinary imaging device (CCD) for imaging by use of visible light and an infrared CCD capable of imaging by use of infrared radiation, either of which can be chosen to be used appropriately. In addition to this constitution, the imaging means 6 is constituted by an illumination means for illuminating the workpiece, an optical system for capturing a region illuminated by the illumination means and a means to transmit the image captured by the optical system to the imaging device (CCD or infrared CCD) and to convert it into electrical image signals, and then the image signals are sent to a control means (not shown).

The laser beam shining unit 5 in the illustrated embodiment has a moving means 53 for moving the unit holder 51 along the pair of guide rails 423, 423 in the direction indicated by the arrows Z. The moving means 53, like the aforementioned respective moving means, comprises an externally threaded rod (not shown) and a drive source such as a pulse motor 532 or the like, for rotationally driving the externally threaded rod, which are disposed between the pair of guide rails 423 and 423. The externally threaded rod (not shown) is driven normally and reversely rotationally by the pulse motor 532, whereby the unit holder 51 and the laser beam shining means 52 are moved along the guide rails 423, 423 in the direction indicated by the arrows Z.

Next, an explanation will be given for a machining method for dividing a semiconductor wafer as a workpiece into individual semiconductor chips by use of the above-described laser machining apparatus.

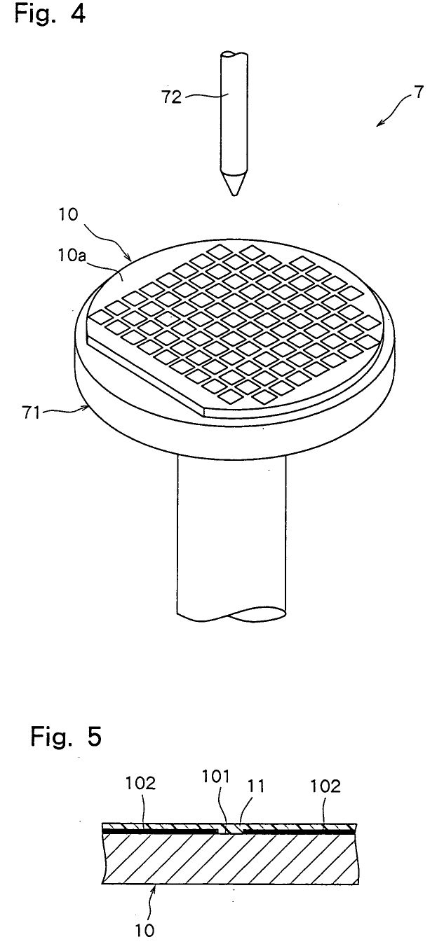

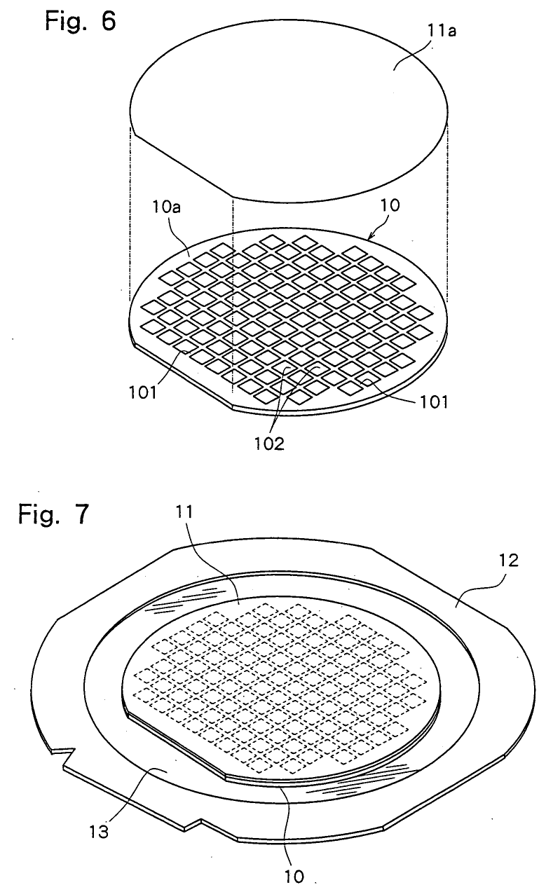

FIG. 3 shows a semiconductor wafer to be divided into individual semiconductor chips by the laser machining method according to the present invention. A semiconductor wafer 10 shown in FIG. 3 has a plurality of regions demarcated by a plurality of streets (cutting lines) 101 arranged in a lattice pattern on a face 10a, and a circuit 102 such as IC, LSI or the like is formed in each of the demarcated regions. To divide the semiconductor wafer 10 into individual semiconductor chips with the use of the above-described laser machining apparatus, the first step is to coat a protective film onto a face 10a that is the surface to be machined, of the semiconductor wafer 10 (protective film coating step). Specifically, the face 10a of the semiconductor wafer 10 is coated with a resin by a spin coater 7, as shown in FIG. 4. That is, the spin coater 7 has a chuck table 71 with a suction-holding means and a nozzle 72 arranged above a central portion of the chuck table 71. The semiconductor wafer 10 is placed on the chuck table 71 of the spin coater 7, with the face 10a facing up. A liquid resin is dripped from the nozzle 72 onto a central portion of the face of the semiconductor wafer 10 while the chuck table 71 is rotated, whereby the liquid resin flows up to an outer peripheral portion of the semiconductor wafer 10 due to a centrifugal force, to coat the face of the semiconductor wafer 10. This liquid resin is hardened with the passage of time to form a protective film 11 on the face 10a of the semiconductor wafer 10, as shown in FIG. 5. A water-soluble resist is desirable as the resin to be coated on the face 10a of the semiconductor wafer 10. For example, TPF (trade name) supplied by TOKYO OHKA KOGYO K.K. is favorably used. As another embodiment of formation of the protective film 11 on the face 10a of the semiconductor wafer 10, a sheet member 11a may be stuck onto the face 10a of the semiconductor wafer 10, as shown in FIG. 6. This sheet member 11a is desirably formed from a water-soluble resin.

When the protective film 11 has been formed on the face 10a of the semiconductor wafer 10 by the above-mentioned protective film coating step, a protective tape 13 mounted on an annular frame 12 is stuck onto a back face of the semiconductor wafer 10, as shown in FIG. 7. The semiconductor wafer 10 supported on the annular frame 12 via the protective tape 13 is conveyed onto the adsorption chuck 361 of the chuck table 36 constituting the chuck table means 3 of the laser machining apparatus shown in FIG. 1, with the face 10a having the protective film 11 formed thereon being faced up. This semiconductor wafer 10 is suction-held by the adsorption chuck 361. The chuck table 36 thus suction-holding the semiconductor wafer 10 thereon is moved along the guide rails 31, 31 by the action of the moving means 37, and is positioned right under the imaging means 6 disposed on the laser beam shining unit 5.

When the chuck table 36 has been positioned right under the imaging means 6, image processings such as pattern matching etc. are carried out by the imaging means 6 and a control means (not shown) for bringing a street 101, which is formed in a predetermined direction on the semiconductor wafer 10, into alignment with the optical condenser 524 of the laser beam shining unit 5 that shines a laser beam along the street 101, whereby alignment of the laser beam shining position is performed. For the street 101 formed on the semiconductor wafer 10 and extending perpendicularly to the above predetermined direction, alignment of the laser beam shining position is also performed similarly. At this time, if the protective film 11 formed on the face 10a having the streets 101 formed thereon, of the semiconductor wafer 10, is not transparent, imaging is carried out using infrared rays, whereby alignment can be performed from the face.

When the street 101 formed in the semiconductor wafer 10 held on the chuck table 36 has been detected and alignment of the laser beam shining position has been performed in the foregoing manner, the chuck table 36 is moved to a laser beam shining area where the optical condenser 524 of the laser beam shining unit 5 for shining a laser beam is located. In this laser beam shining area, a laser beam is shone through the protective film 11 along the street 101 of the semiconductor wafer 10 by the optical condenser 524 of the laser beam shining unit 5 (laser beam shining step).

The laser beam shining step will be described here.

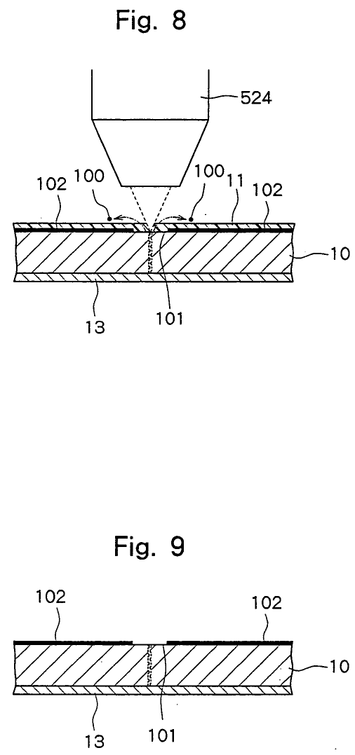

In the laser beam shining step, the chuck table 36, namely, the semiconductor wafer 10 held thereon, is caused to move at a predetermined feed speed (for example, 100 mm/second) in the direction indicated by the arrows X while a pulse laser beam is directed toward the predetermined street 101, through the protective film 11 from the face side that is the surface to be machined, of the semiconductor wafer 10, from the optical condenser 524 of the laser beam shining unit 5 for shining the laser beam, as shown in FIG. 8. In the laser beam shining step, an ultraviolet laser beam and an infrared laser beam as shown below can be used:

(1) Ultraviolet laser beam

Light source: YAG laser or YVO4 laser

Wavelength: 355 nm

Output: 3.0 W

Pulse repetition frequency: 20 kHz

Pulse width: 0.1 ns

Diameter of focusing spot: φ0.5 μm

(2) Infrared laser beam

Light source: YAG laser or YVO4 laser

Wavelength: 1064 nm

Output: 5.1 W

Pulse repetition frequency: 100 kHz

Pulse width: 20 ns

Diameter of focusing spot: φ1 μm

By performing the above-described laser beam shining step, the semiconductor wafer 10 is divided along the street 101. At this time, even if debris 100 are produced at the time of applying the laser beam, as shown in FIG. 8, these debris 100 are shut off by the protective film 11 and do not adhere to the circuit 102, the bonding pads and the like.

After the laser beam shining step has been performed along the predetermined street in the above manner, the chuck table 36, namely, the semiconductor wafer 10 held thereon, is index-moved by a spacing between the streets in the direction indicated by the arrows Y (indexing step), and then the above-mentioned laser beam shining step is performed. After completion of the laser beam shining step and the indexing step along all the streets extending in the predetermined direction, the chuck table 36, namely, the semiconductor wafer 10 held thereon, is turned 90 degrees. Then, the above-described laser beam shining step and the indexing step are carried out along the streets extending perpendicularly to the aforementioned predetermined direction. Thus, the semiconductor wafer 10 is divided into individual semiconductor chips. After the semiconductor wafer 10 has been divided into the individual semiconductor chips as described above, the chuck table 36 holding the semiconductor wafer 10 is returned to the position where the chuck table 36 initially suction-held the semiconductor wafer 10. At this position, the chuck table 36 releases the suction-holding of the semiconductor wafer 10. Then, the semiconductor wafer 10 is conveyed to a subsequent step by a conveyance means (not shown).

Then, a protective film removal step is performed for removing the protective film 11 coated on the face 10a of the semiconductor wafer 10 stuck to the protective tape 13 mounted on the annular frame 12. In this protective film removal step, the protective film 11 can be washed away by water, because the protective film 11 is formed from the water-soluble resin as stated earlier. At this time, the debris 100 that generated during the aforementioned laser beam shining step are also washed out together with the protective film 11. As a result, the semiconductor wafer 10 is divided into the individual semiconductor chips along the streets 101, as shown in FIG. 9. In the illustrated embodiment, as described here, the protective film 11 can be washed away by water, since it is formed from the water-soluble resin. Thus, removal of the protective film 11 is very easy.

As noted above, the present invention has been described based on the embodiments of dividing the semiconductor water, but this invention can be applied to various types of laser machining for other workpieces.

According to the laser machining method of the present invention, the surface to be machined, of the workpiece is coated with the protective film, and a laser beam is applied to the workpiece through the protective film. Therefore, debris produced by applying the laser beam are shut off by the protective film. Since the debris are removed along with the protective film, the influence of the debris generated by shining of the laser beam can be prevented.

What I claim is:

1. A laser machining method for machining a workpiece by applying a laser beam thereto, which comprises:
a protective film coating step of coating a surface to be machined, of the workpiece with a protective film;
a laser beam shining step of applying a laser beam to the workpiece through said protective film; and
a protective film removal step of removing said protective film after completion of said laser beam shining step.

2. The laser machining method according to claim 1, wherein said protective film is formed by coating said to-be-machined surface with a liquid resin and allowing the resulting coating to be hardened with the passage of time.

3. The laser machining method according to claim 2, wherein said liquid resin is water-soluble.

4. The laser machining method according to claim 1, wherein said protective film is formed by sticking a sheet member to said surface to be machined.

5. The laser machining method according to claim 4, wherein said sheet member is water-soluble.

6. The laser machining method according to claim 1, wherein the workpiece is a semiconductor wafer.

7. A laser machining method for cutting a workpiece by moving the workpiece relative to a laser beam shining means while applying a laser beam to the workpiece by said laser beam shining means, which comprises:
a protective film coating step of coating a surface to be machined, of the workpiece with a protective film;
a laser beam shining step of applying a laser beam to the workpiece through said protective film; and
a protective film removal step of removing said protective film after completion of said laser beam shining step.

8. The laser machining method according to claim 7, wherein said protective film is formed by coating said to-be-machined surface with a liquid resin and allowing the resulting coating to be hardened with the passage of time.

9. The laser machining method according to claim 8, wherein said liquid resin is water-soluble.

10. The laser machining method according to claim 7, wherein said protective film is formed by sticking a sheet member to said surface to be machined.

11. The laser machining method according to claim 10, wherein said sheet member is water-soluble.

12. The laser machining method according to claim 7, wherein the workpiece is a semiconductor wafer.
